(19) United States
(12) Patent Application Publication
(10) Pub. No.: US 2023/0328434 A1
(43) Pub. Date: Oct. 12, 2023

(54) LOW COMPLEXITY HOWLING SUPPRESSION FOR PORTABLE KARAOKE

(71) Applicant: HARMAN INTERNATIONAL INDUSTRIES, INCORPORATED, Stamford, CT (US)

(72) Inventors: Jianwen ZHENG, Shenzhen (CN); Shao-Fu SHIH, San Jose, CA (US)

(21) Appl. No.: 18/043,133

(22) PCT Filed: Aug. 27, 2020
(86) PCT No.: PCT/CN2020/111657

§ 371 Date: Feb. 27, 2023

(51) Int. Cl. H04R 3/02; G10H 1/36; H04R 1/40; H04R 3/00; H04R 3/04

(52) U.S. Cl. CPC H04R 3/02; G10H 1/366; H04R 1/406; H04R 3/005; H04R 3/04; G10H 2250/121; G10H 2210/005; H04R 2201/401

(57) ABSTRACT

A low complexity howling suppression system and method for portable karaoke system are provided. In the howling suppression, at least one infinite impulse response (IIR) filters are introduced for estimating the acoustic feedback picked up by the microphone from the real environment, and thereby to cancel out the acoustic feedback from the microphone input signal.

The present invention relates generally to acoustic feedback cancellation technology. More particularly, the present invention relates to a low complexity howling suppression method and system for portable karaoke system.

### BACKGROUND

Karaoke has become more and more popular as an interactive entertainment activity in East Asia. Anyone can sing in a karaoke club using a karaoke machine with their friends. Recently, people are not just satisfied with singing in a club but also sing everywhere with such as a portable all-in-one karaoke machine. Hence, many portable karaoke products have entered the market. However, the sound quality of most of these products are not as good as expected. Many of them suffer from the “acoustic howling” or have not enough sound level due to this howling issue.

In actuality, the howling is a common problem in a karaoke or other sound reinforcement system. A karaoke system usually comprises at least one microphone and a loudspeaker. When a sound signal is picked up by the microphone, and subsequently amplified and fed to the loudspeaker, the loudspeaker sound is usually taken back by the microphone through a direct acoustic path or some reflection paths. The acoustic coupling between the loudspeaker and the microphone results in a closed signal loop, where the acoustic feedback in the form of an unwanted howling can occur. In this case, it either causes the howling problem and even damages the loudspeaker, or limits the performance of the sound reinforcement, since it limits the amount of amplification that can be applied if the karaoke system is required to be stable.

Therefore, different measures have been taken to prevent this problem. There are four major categories of howling suppression methods. The first one is the frequency shifting method, which can alter the microphone input signal in every loop with a frequency shift of several Hz. It will become more helpful when the shifting frequency is bigger, for example 20 Hz, but the side effect on the sound quality is too severe to be considered acceptable. So we usually cannot alter too much and have to compromise on the suppression performance. The second one is the Notch filter based Feedback Suppression (NFS), where notch filters are used to suppress problematic frequencies at which howling has been detected. Notch filters are stop band filters with a very narrow stop band, which can significantly reduce the gain in that particular frequency band and thus suppresses those frequencies from the microphone input signal. However, the NFS method usually includes a detection phase and a suppression phase in the sense that howling sound needs to be detected first, and thus is often heard before it is suppressed. The third one is beamforming method, which uses the microphone array or loudspeaker array to modify the directivities, to reduce the direct sound propagation between the microphones and loudspeakers. But this method requires additional hardware and more computation, and thus the number of microphones and loudspeakers are often limited. The fourth one is the Acoustic Echo Cancellation (AEC) method, which use adaptive filters to approximate the transfer function between the microphones and the loudspeakers, and filter the output signal from the loudspeaker in order to cancel the approximated feedback signal picked up by the microphone. If the transfer function is perfectly approximated by the adaptive filters, no howling comes out. Usually AEC method can perform well thanks to the adaptive mechanism, but it takes high computation and power consumption, as well as the long system processing time, which is not suitable in the portable karaoke system with certain play time and latency requirement.

However, most of these measures are focusing on the regular big karaoke system, in which the distance between the loudspeaker and the microphone is usually much farther than that in the portable all-in-one karaoke system. On the other hand, users would probably like to sing as loud as possible even in such a small karaoke machine. Therefore, if we want to exceed user's expectation in the karaoke product, we need to develop a better technique to suppress the howling.

### SUMMARY OF THE INVENTION

The present invention overcomes some of the above drawbacks by providing a low complexity howling suppression system for portable karaoke system. The howling suppression system comprising at least one microphone for capturing an input signal which comprises a source signal and an acoustic feedback which is propagated through environment; an electro-acoustic path for compressing and equalizing the input signal, and then feeding to an output signal after amplified; a loudspeaker for playback the output signal. The howling suppression system further comprises at least one infinite impulse response (IIR) filters for estimating the acoustic feedback, and thereby to cancel out the acoustic feedback from the input signal.

The present invention further provides a low complexity howling suppression method for portable karaoke system. The howling suppression method comprises the steps of capturing an input signal which comprises a source signal and an acoustic feedback via at least one microphone, compressing and equalizing the input signal, in an electro-acoustic path, and then feeding an output signal to a loudspeaker after amplified, and playback the output signal with a loudspeaker, and the output signal is propagated through environment. The howling suppression method further comprises the step of estimating the acoustic feedback via at least one infinite impulse response (IIR) filters, and thereby to cancel out the acoustic feedback from the input signal.

### BRIEF DESCRIPTION OF THE DRAWINGS

The present invention may be better understood from reading the following description of non-limiting embodiments, with reference to the attached drawings. In the figures, like reference numeral designates corresponding parts, wherein below:

FIG. 1 illustrates an example howling scenario in a karaoke system with one microphone and one loudspeaker.

FIG. 2A-2B illustrate an example system diagram for the howling suppression in the karaoke system according to the present invention.

FIG. 3 illustrates an example flowchart illustrating the howling suppression method according to the present invention.

FIG. 4 illustrates an example hardware system for the portable all-in-one karaoke system according to the present invention.

FIG. 5A-5E illustrate some simulated comparison results related to the present invention, wherein FIG. 5A shows the spectrogram of the loudspeaker signal; FIG. 5B shows the spectrogram of the loudspeaker signal with howling sound at around 2 kHz and 9.3 kHz; FIG. 5C shows the spectrogram obtained with the frequency shifting method; FIG. 5D shows the spectrogram obtained with the NFS method, and FIG. 5E shows the spectrogram obtained with the present invention.

### DETAILED DESCRIPTION OF THE INVENTION

The detailed description of one or more embodiments of the present invention is disclosed hereinafter; however, it is understood that the disclosed embodiments are merely exemplary of the invention that may be embodied in various and alternative forms. The figures are not necessarily to scale; some features may be exaggerated or minimized to show details of particular components. Therefore, specific structural and function details disclosed herein are not to be interpreted as limiting, but merely as a representative basis for teaching one skilled in the art to variously employ the present invention.

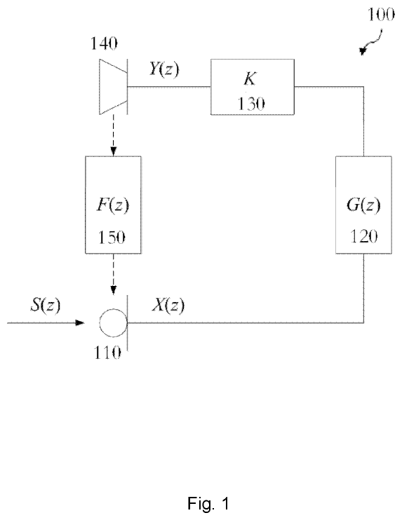

FIG. 1 illustrates an example howling scenario in a karaoke system with one microphone and one loudspeaker. As can be seen in FIG. 1, the system 100 comprises a microphone 110 and a loudspeaker 140, and the microphone 110 is connected to an electro-acoustic path 120 and then connected to the loudspeaker after amplified 130. When the karaoke system is set up, a source signal S(z) from user's singing voice is captured by the microphone 110, and the input signal X(z) is processed in the electro-acoustic path G(z), including the compression and equalization, and then amplified by a gain factor K. The output signal Y(z) is fed to the loudspeaker 140 and propagated through the environment 150.

When the sound signal is picked up by the microphone 110 and subsequently amplified and fed to the loudspeaker 140, the audio sound playback by the loudspeaker 140 can be taken back by the microphone 110 through direct or reflection paths. The acoustic coupling between the loudspeaker 140 and the microphone 110 results in the output signal Y(z) propagated through the environmental transfer function F(z) to form an acoustic feedback, and then also picked up into the microphone 110, and thus the input signal X(z) as shown in FIG. 1 comprises both the source signal S(z) and the acoustic feedback Y(z)·F(z).

Therefore, with all the signals and transfer functions denoted in the frequency domain, the process in FIG. 1 can be expressed by the following equations:

Y(z)=X(z)·G(z)·K (1)

X(z)=Y(z)·F(z)+S(z) (2)

Regarding the above equation (2), it is conceivable that the input signal X(z) into the karaoke system may further include an Audio Stream, such as accompaniment music of a song, input by way of Bluetooth or AUX interface, for example, which has been omitted herein.

And then we can compute the total transfer function H(z) from the source signal S(z) to the output signal Y(z):

$$H ( z ) = \frac{Y ( z )}{S ( z )} = \frac{G ( z ) \cdot K}{1 - F ( z ) \cdot G ( z ) \cdot K} \qquad ( 3 )$$

where the term F(z)·G(z)·K refers to the loop response of the system, and the magnitude and phase responses of it denote the loop gain and loop phase, respectively. Therefore, the howling will occur when the system becomes unstable, which is summarized in the Nyquist stability criterion,

F(z)·G(z)·K≥1, ∠F(z)G(z)=n2π (4)

In the past several decades, many methods on howling suppression have been discussed. Certainly, the first precaution to be considered is optimizing the whole karaoke system, such as the directivities of the loudspeaker and the microphone, the distance between them, the overall gain of the system and the amplitude of some potentially problematic frequencies. However, the optimization is usually limited, especially in the portable all-in-one karaoke system, because its form factor and sound performance usually have certain requirements—as small size but as high sound level as possible. For these limited scenarios, the processes must be automated or other measures needs to be taken to avoid howling feedback. Therefore, the present invention provides a portable all-in-one karaoke system with low complexity howling suppression method.

To better suppress the howling sound in the portable all-in-one karaoke machine, and reduce the processing computation, the power consumption, and the system latency, the present invention provides a low-complexity howling suppression method for portable karaoke system, in which filters are used to cancel unwanted components from the microphone signal.

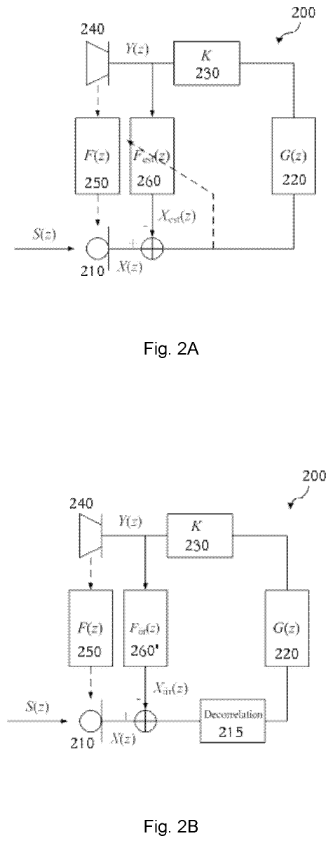

FIG. 2A illustrates an example system diagram for the howling suppression in the karaoke system according to the present invention. A filter 260 is introduced into this system 200, Fₑₛₜ(z) is an estimated transfer function established by the filter 260, which is designed and adapted to resemble the actual environment transfer function F(z) in the environment 250. Many algorithms have been proposed to realize this method, such as Least Mean Square and Normalized Least Mean Square algorithm. In the example of FIG. 2A, if Fₑₛₜ(z) converges perfectly and thus Fₑₛₜ(z)=F(z), Xₑₛₜ(z)=X(z), all feedback signals from the loudspeaker 240 will be canceled, hence the input signal only consists of the source signal S(z) from such as the user's singing voice but the howling will not occur, which can be expressed as below equation:

X(z)−Xₑₛₜ(z)=S(z)+F(z)Y(z)−Fₑₛₜ(z)Y(z)≈S(z) (5)

Using an adaptive filter to estimate the environmental transfer function can achieve good effect of suppressing howling. In practice, however, the howling suppression with the adaptive filter estimating the environmental transfer function still exists some problems. Firstly, the latency may not meet the requirement of this small karaoke machine. Since the adaptive algorithm might need long processing time, while the loudspeaker is very close to the microphone, so that the sound propagation time is probably smaller than the processing time, and thus the algorithm becomes ineffective. Secondly, the adaptive algorithm might also consume high power and the battery will drain quickly, which is the obvious defect of a portable device. Thirdly, the adaptive algorithm sometimes does not converge smoothly, resulting in the significant difference of the adaptive filters, which will constantly affect the timbre of the user's singing. Furthermore, there is high correlation between the loudspeaker and microphone in the karaoke system, which renders this structure to perform poorly in this scenario.

Therefore, in the example system, several second-order Infinite Impulse Response (IIR) filters 260′ are used to model the transfer function F(z), as shown in FIG. 2B. Since the form factor of the portable all-in-one karaoke system determines the fixed distance between the loudspeaker 240 and the microphone 210, we can measure and estimate the transfer function Fᵢᵢᵣ(z) offline and approximate it by multi-band IIR filters. Moreover, in certain situations such as the integrated karaoke machine, the relative position of the loudspeaker and microphone is relatively fixed, so that even if the adaptive process is not required, 80˜90% of the howling suppressing effect can be achieved, and the IIR filters can have a fixed suppression effect. Using the IIR filters in this system not only saves power consumption, but also saves chip computing resources.

Besides, the decorrelation 215 can be further introduced into the example system 200 to reduce the correlation between the loudspeaker and microphone signals. In the model as shown in FIG. 2B, the loudspeaker signal is decorrelated from the microphone signal by frequency shifting the input signal before the compression and the equalization, which means, in the decorrelation 215, the total input signal X(z)−Xᵢᵢᵣ(z) is frequency shifted, and results in Y(z) and X(z)−Xᵢᵢᵣ(z) are decorrelated. Thus, the output signal is decorrelated from the input signal. For example, the frequency shifted output signal x_{shift}(t) can be obtained as below in the time domain,

x_{shift}(t)=x(t)cos(2πΔft)−\hat{x}(t)sin(2πΔft) (6)

where Δf is the shifted frequency, and \hat{x}(t) is the Hilbert transform of the original signal x(t).

The full advantage of the frequency shifting can be taken into the present method. In this proposed model with several IIR filters modeling the environmental transfer function, there is no need the adaptive processing due to the latency problem and high-power consumption. Moreover, since the acoustic feedback problem occurs because the output signal of the loudspeaker is returned to the input microphone through the part of acoustic coupling in the air, the frequency shift is used to decorrelate the reference signal and the error signal, which can be used to mitigate biased filter estimation.

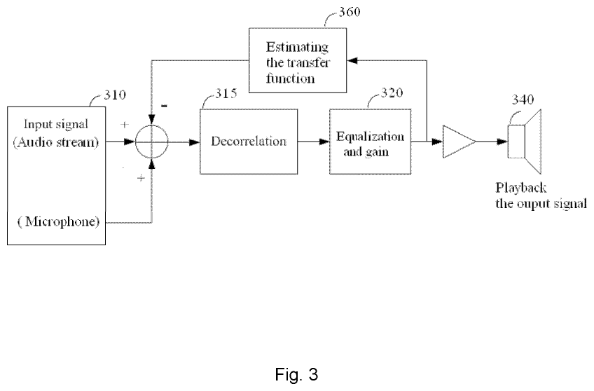

FIG. 3 illustrates an example flowchart illustrating the howling suppression method according to the present invention.

In Step 310, the input signal is provided into the portable karaoke system, which comprises the source signal such as the user's singing voice, and the acoustic feedback. This part of the input signal captured by the at least one microphone; Moreover, the input signal further comprises the audio stream such as the accompanying music of songs, this part of the input signal may be upload to the karaoke system in a wired or wireless way, such as by Bluetooth or via the AUX interface.

In Step 315, the decorrelation is introduced into the provided system to decorrelate the input signal. In this step, the loudspeaker signal of the loudspeaker is decorrelated from the input signal by frequency shifting the input signal.

In Step 320, then the frequency shifted input signal is processed in the electro-acoustic path, including compression and equalization, and then amplified by the gain factor K, to get the output signal.

In Step 340, the output signal is fed to the loudspeaker for playback and propagated through the environment.

In this step, the output signal playback from the loudspeaker, after propagated in the environment, is taken back by the microphone through a direct or some reflection paths as acoustic feedback, the acoustic feedback enters the microphone as the other part of the input signal received by the at least one microphone, as mentioned above in Step 310.

Next, in Step 360, in order to cancel out unwanted components from the microphone signal, several IIR filters are used to model the environmental transfer function. This step comprises measuring and estimating the environmental transfer function offline, and approximates the function by such as multi-band IIR filters. The resulting estimated signal is approximately equal to the acoustic feedback part of the input signal entering the microphone in step 350. Therefore, by subtracting the estimated acoustic feedback from the input signals captured by the microphone, the acoustic feedback that may produce howling in the system can be cancelled out.

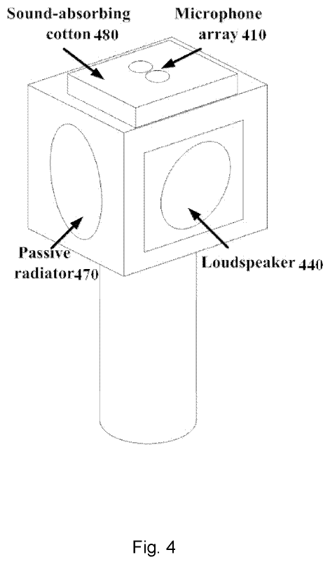

FIG. 4 illustrates an example hardware system for the portable all-in-one karaoke system according to the present invention, in which the low complexity howling suppression method provided herein is implemented. As depicted in FIG. 4, the beamforming technique using microphone arrays or loudspeaker arrays to modify directivity are additionally used in the howling suppression method.

In a way of example, two microphones with different directivities as a microphone array 410 are used to form a cardioid directivity pattern as shown in FIG. 4. This can also be regarded as a special beamforming arrangement to suppress more howling components. It can be understood that more microphones can be used to arrange the microphone array.

The beamforming output X_{beam}(z) is written as:

X_{beam}(Z)=ΣₖWₖ(z)·Xₖ(Z) (7)

where Wₖ(z) and Xₖ(z) are the kth beamforming filter and the kth microphone input signal, respectively.

Moreover, In the actual portable karaoke products, the microphones 410 can be wrapped with the sound-absorbing cotton 480 to further reduce the sound energy from the loudspeaker 440. We can see that the passive radiator 470 is alternatively used in this example machine, as shown schematically in FIG. 4.

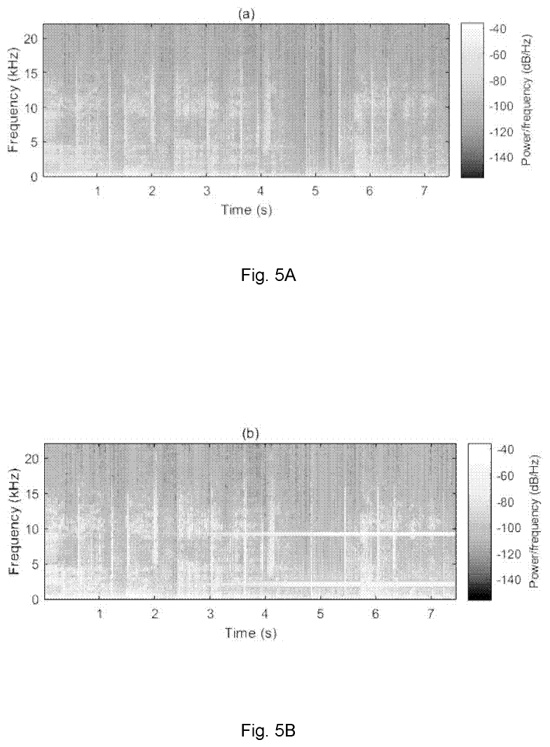

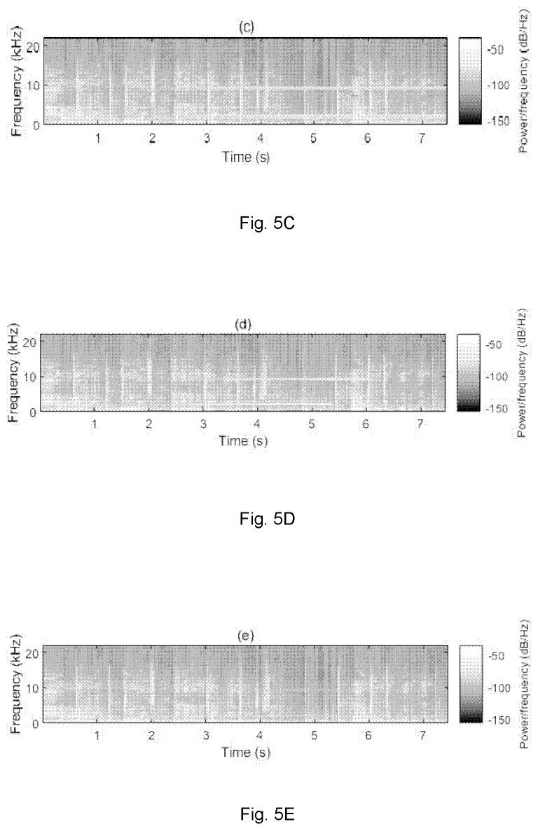

FIG. 5A-5E demonstrates some simulated comparison results. FIG. 5A shows the spectrogram of the loudspeaker signal and FIG. 5B illustrates the howling sound at around 2 kHz and 9.3 kHz, which increases dramatically and lasts till the end. In FIG. 5C with frequency shifting method, the howling frequencies are shifted down in every loop and the power of them is suppressed at a lower level, but the howling is still noticeable. FIG. 5D shows that the NFS method can suppress the howling successfully but it starts to work only after the howling is audible and detected. The spectrogram obtained with the low complexity howling suppression method provided in the present invention, shown in FIG. 5E, indicates no obvious increase of sound energy at the problematic frequencies, meaning that the provided method can successfully and significantly suppress the howling feedback, performing best among these methods.

For a portable karaoke machine, we always want to have a long play time but still expect a good sound quality, such as high volume and less howling problem. In this invention, the provided low complexity howling suppression method adopts the IIR filter structure to reduce the power consumption and the system latency. To further suppress the howling, nonlinear algorithms, for example frequency shifting, are also combined with the microphone beamforming method.

The low complexity howling suppression method and system provided in the present invention are suitable for those applications in which a system containing both loudspeaker and microphone provided that their relative positions are fixed, and the loudspeaker plays the input signal of the microphone in real time. The example applications comprise such as but not limited to portable karaoke machines, integrated speakers, and conference systems, etc.

As used in this application, an element or step recited in the singular and proceeded with the word “a” or “an” should be understood as not excluding plural of said elements or steps, unless such exclusion is stated. Furthermore, references to “one embodiment” or “one example” of the present disclosure are not intended to be interpreted as excluding the existence of additional embodiments that also incorporate the recited features. The terms “first,” “second,” and “third,” etc. are used merely as labels, and are not intended to impose numerical requirements or a particular positional order on their objects.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A low complexity howling suppression method for a portable karaoke system, the method comprising the steps of:
capturing, by at least one microphone, an input signal which comprises a source signal and an acoustic feedback;
compressing and equalizing, in an electro-acoustic path, the input signal, and then feeding to an output signal after being amplified;
playing back, by a loudspeaker, the output signal which is propagated through environment; and
estimating, by at least one infinite impulse response (IIR) filter, the acoustic feedback, and thereby to cancel out the acoustic feedback from the input signal.

2. The method of claim 1, wherein the acoustic feedback comprises howling generated in a closed signal loop caused by acoustic coupling between the loudspeaker and the at least one microphone.

3. The method of claim 1, further comprising the step of modeling, by the at least one IIR filter, an environmental transfer function.

4. The method of claim 3, wherein relative position of the at least one microphone and the loudspeaker is fixed.

5. The method of claim 3, wherein modeling the environmental transfer function comprises measuring and estimating the environmental transfer function offline and approximating the environmental transfer function.

6. The method of claim 5, wherein approximating the environmental transfer function can be performed by multi-band IIR filters.

7. The method of claim 3, further comprises decorrelating the output signal from the input signal.

8. The method of claim 7, wherein decorrelating the output signal from the input signal can be implemented by frequency shifting the input signal.

9. The method of claim 1, further comprising the step of arranging the at least one microphone in different directivities as a microphone array for beamforming.

10. The method of claim 9, wherein the microphone array forms a cardioid directivity pattern.

11. A portable karaoke system with low complexity howling suppression, the system comprising:
at least one microphone for capturing an input signal which comprises a source signal and an acoustic feedback which is propagated through environment;
an electro-acoustic path for compressing and equalizing the input signal, and then feeding to an output signal after amplified;
a loudspeaker for playback the output signal; and
at least one infinite impulse response (IIR) filter for estimating the acoustic feedback, and thereby to cancel out the acoustic feedback from the input signal.

12. The system of claim 11, wherein the acoustic feedback comprises howling generated in a closed signal loop caused by acoustic coupling between the loudspeaker and the at least one microphone.

13. The system of claim 11, wherein the at least one IIR filter further models an environmental transfer function.

14. The system of claim 13, wherein relative position of the at least one microphone and the loudspeaker is fixed.

15. The system of claim 13, wherein the at least one IIR filter further measures and estimates the environmental transfer function offline and approximates the environmental transfer function.

16. The system of claim 15, wherein the environmental transfer function can be approximated by multi-band IIR filters.

17. The system of claim 13, further comprising a decorrelator for decorrelating the output signal from the input signal.

18. The system of claim 17, wherein decorrelating the output signal from the input signal can be implemented by frequency shifting the input signal.

19. The system of claim 11, wherein the at least one microphone includes microphones that are further arranged in different directivities as a microphone array for beamforming.

20. The system of claim 19, wherein the microphone array forms a cardioid directivity pattern.
